(19) United States
(12) Patent Application Publication
(10) Pub. No.: US 2023/0172279 A1
(43) Pub. Date: Jun. 8, 2023

(54) POWER MANAGEMENT FOR AEROSOL PROVISION DEVICE

(71) Applicant: Nicoventures Trading Limited, London (GB)

(72) Inventors: Patrick Moloney, London (GB); Justin Han Yang Chan, London (GB)

(21) Appl. No.: 17/998,097

(22) PCT Filed: May 5, 2021
(86) PCT No.: PCT/GB2021/051086

§ 371 Date: Nov. 7, 2022

(30) Foreign Application Priority Data
May 7, 2020 (GB) 2006798.9

(51) Int. Cl. A24F 40/53; A24F 40/10; A24F 40/44

(52) U.S. Cl. CPC A24F 40/53; A24F 40/10; A24F 40/44

(57) ABSTRACT

An apparatus, method and computer program are described, including: monitoring, by the control circuitry, at least one operating parameter of the electronic aerosol delivery system; controlling, by the control circuitry, at least one control parameter of the electronic aerosol delivery system to generate an aerosol having a first aerosol profile during a first puff; determining, by the control circuitry, a change in one or more of the operating parameters; modifying, by the control circuitry, in response to determining a change in one or more of the operating parameters, a control parameter of the electronic aerosol delivery system to generate an aerosol having a second aerosol profile during a subsequent puff.

### PRIORITY CLAIM

The present application is a National Phase entry of PCT Application No. PCT/GB2021/051086, filed May 5, 2021, which claims priority from GB Application No. 2006798.9, filed May 7, 2020, each of which is hereby fully incorporated herein by reference.

### TECHNICAL FIELD

The present disclosure relates to a system and method of aerosol delivery.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Electronic aerosol delivery devices such as electronic cigarettes (e-cigarettes) generally contain a reservoir of a source liquid containing a formulation, typically including an active material such as nicotine, from which an aerosol is generated, e.g. through vaporization. An aerosol source for an aerosol delivery device may thus comprise an aerosol generating component such as a heater having a heating element arranged to receive source liquid from the reservoir, for example through wicking/capillary action. Other source materials may be similarly heated to create an aerosol, such as botanical matter, or a gel comprising an active ingredient and/or flavoring. Hence more generally, the e-cigarette may be thought of as comprising or receiving a payload for heat vaporization.

While a user inhales on the device, electrical power is supplied to the heating element to vaporize a portion of aerosolizable material in the vicinity of the heating element, to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol generating component. There is a flow path connecting between the aerosol generating component and an opening in the mouthpiece so that air drawn past the aerosol source continues along the flow path to the mouthpiece opening, carrying some of the aerosol generated by the aerosol generating component with it. The aerosol-carrying air exits the aerosol delivery device through the mouthpiece opening for inhalation by the user.

Usually an electric current is supplied to the heater when a user is drawing/puffing on the device. Typically, the electric current is supplied to the heater, e.g. resistance heating element, in response to either the activation of an airflow sensor along the flow path as the user inhales/draw/puffs or in response to the activation of a button by the user. The heat generated by the heating element is used to vaporize a formulation. The released vapor mixes with air drawn through the device by the puffing consumer and forms an aerosol. Alternatively or in addition, the heating element is used to heat but typically not burn a botanical such as tobacco, to release active ingredients thereof as a vapor/aerosol.

One or more control parameters of an electronic aerosol delivery device may be set by a user in order to generate aerosol having a certain aerosol profile. For example, the power supplied to the aerosol generating component may be set to higher or lower values depending on, for instance, an aerosol density characteristic, aerosol particle size characteristic, or nicotine delivery characteristic which is desirable for the user. Other control parameters may be adjustable by the user and/or control circuitry of the device, such as the resistance to draw and the selection and/or feed rate of aerosolizable material. Changing these control parameters will change characteristics of the aerosol produced by the electronic aerosol delivery device, and thereby alter the aerosol profile. Characteristics of an aerosol generated by the electronic aerosol delivery device may also vary in dependence of operating parameters not under the direct control of either the user or of control circuitry comprised in the device. For example, degradation of components in the electronic aerosol delivery device (e.g. the battery or aerosol generating component) may change one or more characteristics of the generated aerosol. Accordingly, operating parameter changes may cause the aerosol profile of aerosol generated by the electronic aerosol delivery device to change, even if the control parameters of the device are unchanged. Accordingly, the aerosol profile of aerosols generated by the electronic aerosol delivery device may change over time without a user seeking to control said changes via adjustment of control parameters. This may lead to user dissatisfaction.

Accordingly ways of improving user satisfaction with electronic aerosol delivery devices where operating parameters may change is of interest.

### SUMMARY

In a first aspect of the disclosure there is provided an electronic aerosol delivery system, comprising control circuitry; wherein the control circuitry is configured to monitor at least one operating parameter of the electronic aerosol delivery system; wherein the control circuitry is configured to control at least one control parameter of the electronic aerosol delivery system to generate an aerosol having a first aerosol profile during a first puff; wherein the control circuitry is configured to determine a change in one or more of the operating parameters; wherein the control circuitry is configured, in response to determining a change in one or more of the operating parameters, to modify a control parameter of the electronic aerosol delivery system to generate an aerosol having a second aerosol profile during a subsequent puff.

The at least one operating parameter and the at least one control parameter may be associated with one of the following aspects of operation: (a) supply of power to an aerosol generating component, (b) control of airflow in the aerosol delivery system, (c) supply of aerosolizable material to an aerosol generating component, or (d) other aspects of device operation; and wherein the control parameter modified by the control circuitry may be associated with a different aspect of operation to that of the at least one of the operating parameter which is determined to have changed.

The control parameter may be modified in a manner which mitigates against a change in one or more characteristics of the first aerosol profile resulting from the change in one or more of the operating parameters.

The first aerosol profile may comprise a plurality of aerosol characteristics, and wherein the control parameter is selected to mitigate against a change in one or more of the plurality of aerosol characteristics, and wherein the one or more of the aerosol characteristics are selected from the plurality of aerosol characteristics based on a predetermined priority ranking of the plurality of aerosol characteristics.

The priority ranking of the plurality of aerosol characteristics may be associated with a specific user of the electronic aerosol delivery system.

The aerosol delivery system may comprise an aerosol generating component, and wherein determining a change in the one or more operating parameters comprises determining a change in an operating parameter of the aerosol generating element.

The change in the operating parameter of the aerosol generating component may comprise determining a change in the capacity of the power supply to supply power to the aerosol generating component. Determining the change in the capacity of the power supply to supply power to the aerosol generating component may comprise determining that a value associated with the amount of energy remaining in the battery has changed with respect to a predefined threshold.

The control circuitry may be configured to control the supply of power from the power supply to the aerosol generating component in accordance with a power supply parameter specifying an amount of power to be supplied to the atomizer, and wherein determining the change in the capacity of the power supply to supply power to the aerosol generating component comprises determining that the battery is not able to supply the amount of power specified by the power supply parameter.

Determining the change in the operation of the aerosol generating component may comprise determining a physical characteristic of the aerosol generating component has changed.

Aerosolizable material may be supplied to the aerosol generating component from a supply of aerosolizable material, and wherein the at least one operating parameter comprises a parameter controlling the supply of aerosolizable material to the aerosol generating component.

Modifying the parameter controlling the supply of aerosolizable material to the aerosol generating component may change a rate at which aerosolizable material is supplied to the aerosol generating component.

Modifying the supply of aerosolizable material to the aerosol generating component may comprise modifying the composition of aerosolizable material supplied to the aerosol generating component. Modifying the composition of the aerosolizable material supplied to the aerosol generating component may comprise modifying a concentration of water, active material, olfactory component, or an aerosol-forming constituent.

The electronic aerosol delivery system may comprise an air flow path between an air inlet and an air outlet, wherein the aerosol generating component is disposed within the air flow path, and wherein the operating parameter comprises a parameter which modifies the air flow path. Modifying the characteristic of the air flow path may comprise modifying the resistance to draw of air flow through the air flow path.

Modifying the characteristic of the air flow path may comprise modifying the manner in which incident air flowing from the air inlet is directed at the aerosol generating component.

Modifying the characteristic of the air flow path may comprise modifying the temperature of the aerosol generating component disposed in the air flow path.

The control circuitry may be configured to determine how to modify the at least one control parameter using a model which relates one or more operating parameters to one or more aerosol characteristics, wherein the operating parameters comprise at least one control parameter.

The model may be parameterized using experimental data describing how at least one aerosol characteristic of an aerosol generated by the electronic aerosol delivery system varies as a function of different operating parameter values.

The control circuitry may be configured to determine how to modify the at least one control parameter using a classifier which takes at least one operating parameter value as an input, and returns at least one control parameter value as an output. The classifier may be trained using usage data describing the relationship between one or more operating parameter changes and one or more control parameter changes determined by one or more users in response to the one or more operating parameter changes.

In a further aspect, there is provided control circuitry for an electronic aerosol delivery system, wherein the control circuitry is configured to: monitor at least one operating parameter of the electronic aerosol delivery system; control at least one control parameter of the electronic aerosol delivery system to generate an aerosol having a first aerosol profile during a first puff;

determine a change in one or more of the operating parameters; modify, in response to determining a change in one or more of the operating parameters, a control parameter of the electronic aerosol delivery system to generate an aerosol having a second aerosol profile during a subsequent puff.

In a further aspect, there is provided a method of controlling an electronic aerosol delivery system comprising control circuitry, the method comprising: monitoring, by the control circuitry, at least one operating parameter of the electronic aerosol delivery system; controlling, by the control circuitry, at least one control parameter of the electronic aerosol delivery system to generate an aerosol having a first aerosol profile during a first puff; determining, by the control circuitry, a change in one or more of the operating parameters; modifying, by the control circuitry, in response to determining a change in one or more of the operating parameters, a control parameter of the electronic aerosol delivery system to generate an aerosol having a second aerosol profile during a subsequent puff.

In a further aspect, there is provided a computer program for an electronic aerosol delivery system, wherein the computer program is configured to: monitor at least one operating parameter of the electronic aerosol delivery system; control at least one control parameter of the electronic aerosol delivery system to generate an aerosol having a first aerosol profile during a first puff; determine a change in one or more of the operating parameters; modify, in response to determining a change in one or more of the operating parameters, a control parameter of the electronic aerosol delivery system to generate an aerosol having a second aerosol profile during a subsequent puff.

Further aspects are provided in accordance with the claims.

It is to be understood that both the foregoing general summary of the disclosure and the following detailed description are exemplary, but are not restrictive, of the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically shows an electronic aerosol/vapor delivery system.

FIG. 2 schematically shows further details of the electronic aerosol delivery device.

FIG. 3 schematically shows further details of the electronic aerosol delivery device.

FIG. 4 schematically shows further details of the electronic aerosol delivery device.

FIG. 5 schematically shows a system comprising the electronic aerosol delivery device and a remote/external device.

FIG. 6 schematically shows an approach for acquiring data to be used for deriving a model relating operating parameters of the aerosol delivery device to characteristics of an aerosol generated using said operating parameters.

FIGS. 7A to 7D schematically show an approach for using a model to select control parameter values for an aerosol delivery device.

### DETAILED DESCRIPTION

An electronic aerosol delivery system, device, circuitry and method are disclosed. In the following description, a number of specific details are presented in order to provide a thorough understanding of the embodiments of the present disclosure. It will be apparent, however, to a person skilled in the art that these specific details need not be employed to practice embodiments of the present disclosure. Conversely, specific details known to the person skilled in the art are omitted for the purposes of clarity where appropriate.

As described above, the present disclosure relates to an electronic aerosol delivery device (e.g. a non-combustible aerosol delivery device) or vapor delivery device (electronic aerosol delivery device), such as an e-cigarette or nebulizer. Throughout the following description the term “e-cigarette” is sometimes used but this term may be used interchangeably with (electronic) aerosol/vapor delivery system. Similarly the terms ‘vapor’ and ‘aerosol’ are referred to equivalently herein. The term electronic aerosol delivery device may also be used to refer to electronic devices which generate aerosol through controlled combustion of plant material such as tobacco.

Generally, the electronic aerosol delivery device may be an electronic cigarette, also known as a vaping device or electronic nicotine delivery system, although it is noted that the presence of nicotine in the aerosolizable material is not a requirement. In some embodiments, a non-combustible aerosol delivery device is a tobacco heating system, also known as a heat-not-burn system. In some embodiments, the non-combustible aerosol delivery device is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosolizable material and a solid aerosolizable material. The solid aerosolizable material may comprise, for example, a tobacco or a non-tobacco product. Meanwhile in some embodiments, the non-combustible aerosol delivery device generates a vapor or aerosol from one or more such aerosolizable materials.

Typically, the aerosol delivery system may comprise a non-combustible aerosol delivery device and an article for use with the non-combustible aerosol delivery device. However, it is envisaged that articles which themselves comprise a means for powering an aerosol generating component may themselves form the non-combustible aerosol delivery device. In one embodiment, the non-combustible aerosol delivery device may comprise a power source and control circuitry. The power source may be an electric power source.

In some embodiments, the aerosol generating component is a heater capable of providing heat to a portion of aerosolizable material stored in the device so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In some embodiments, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The aerosol forming material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more functional materials may comprise one or more of flavors, carriers, pH regulators, stabilizers, and/or antioxidants.

In some embodiments, the article for use with the electronic aerosol delivery device may comprise aerosolizable material or an area for receiving aerosolizable material. In one embodiment, the article for use with the non-combustible aerosol delivery device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

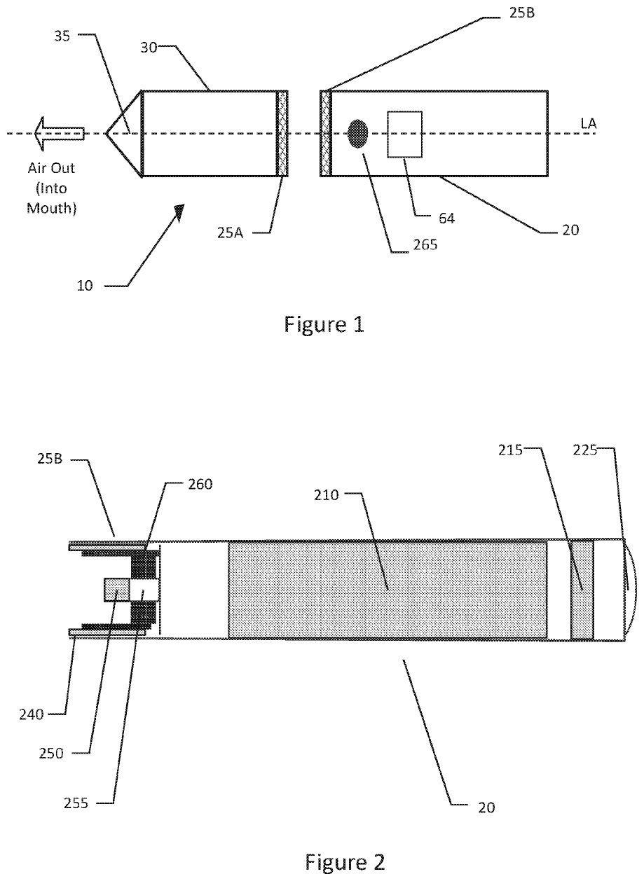

Referring now to the drawings, wherein like reference numerals designate identical or corresponding parts throughout the several views, FIG. 1 is a schematic diagram of an electronic aerosol delivery device such as an e-cigarette 10 in accordance with some embodiments of the disclosure (not to scale). The electronic aerosol delivery device has a generally cylindrical shape, extending along a longitudinal axis indicated by dashed line LA, and comprises two main components, namely a control body 20 and a cartomizer 30. The cartomizer 30 includes an internal chamber containing a reservoir of a payload such as for example a liquid comprising nicotine, a vaporizer (such as a heater), and a mouthpiece 35. References to ‘nicotine’ hereafter will be understood to be merely exemplary and can be substituted with any suitable active ingredient. References to ‘liquid’ as a payload hereafter will be understood to be merely exemplary and can be substituted with any suitable payload such as botanical matter (for example tobacco that is to be heated rather than burned), or a gel comprising an active ingredient and/or flavoring. The reservoir may comprise a foam matrix or any other structure for retaining the liquid until such time that it is required to be delivered to the vaporizer. In the case of a liquid/flowing payload, the aerosol generating component is for vaporizing the liquid, and the cartomizer 30 may further include a wick or similar facility to transport a small amount of liquid from the reservoir to a vaporizing location on or adjacent the aerosol generating component. In the following, a heater is used as a specific example of an aerosol generating component. However, it will be appreciated that other forms of aerosol generating component (for example, those which utilize ultrasonic waves) could also be used and it will also be appreciated that the type of aerosol generating component used may also depend on the type of payload to be vaporized.

In some cases, the electronic aerosol delivery device may comprise a plurality of reservoirs, and/or a plurality of wicks, and/or a plurality of aerosol generating components. These arrangements can enable one or more characteristics of aerosol generated by the device to be controlled by adjusting, for example, the rate of supply of aerosolizable material for aerosolization and/or the composition of aerosolizable material supplied for aerosolization. Accordingly the aerosol profile of an aerosol generated by the electronic aerosol delivery device can be adjusted. In some examples, controlling the rate of aerosolization of aerosolizable material from the reservoir comprises selectively activating certain ones of a plurality of aerosol generating components (e.g. heaters), each of which may be provided with its own individual transport means (e.g. a wick) for transporting aerosolizable material from one or more reservoirs to the aerosol generating component. Increasing the number of heaters activated during aerosol generation can change the aerosol profile of an aerosol generated by the electronic aerosol delivery device by, for example, increasing the amount of aerosol generated. Alternatively or additionally, the rate of aerosolization of one or more aerosolizable materials may be achieved by controlling the rate of transport of the one or more aerosolizable material to an aerosolization zone proximate to one or more aerosol generating components, via means such as pumping.

In some examples, the profile of an aerosol generated by the aerosol delivery device may be selectively modified by aerosolizing different aerosolizable materials from different reservoirs and controlling the relative aerosolization rate of the different aerosolizable materials. For instance, the electronic aerosol delivery device may comprise a plurality of reservoirs configured to hold different aerosolizable materials, with each reservoir supplying aerosolizable material to a different aerosol generating component from a plurality of aerosol generating components. The plurality of aerosol generating components may be separately controllable (for instance, the supplied power may be controllable) by control circuitry in the electronic aerosol delivery device to control the ratio of different aerosolizable materials in an aerosol generated by the device. Alternatively or additionally, the rate of delivery of aerosolizable material to each of one or more aerosol generating components from each of a plurality of reservoirs may be controlled via, for example, changing a rate of pumping. In this case a single aerosol generating component may be configured to receive aerosolizable material from a plurality of reservoirs holding different aerosolizable materials, and the rate of pumping of aerosolizable material from each reservoir to the aerosol generating component can be modified to change to composition of an aerosol generated by the device. In some cases, a plurality of reservoirs may be provided via a plurality of cartridges configured to be coupled for use to the control body 20. Each cartridge may be configured broadly in the manner described for cartomizer 30, with a separate aerosol generating component and reservoir. Each of the plurality of cartridges may be coupled to the control body 20 according to approaches described further herein. The aerosol provision device may be configured such that air passages comprised in each of the plurality of cartridges unite at a position upstream of mouthpiece 35 such that aerosol generated in one or more cartridges can be mixed prior to inhalation by a user.

The control body 20 includes a re-chargeable cell or battery to provide power to the e-cigarette 10 and a circuit board for generally controlling the e-cigarette. When the heater receives power from the battery, as controlled by the circuit board, the heater vaporizes the liquid and this vapor is then inhaled by a user through the mouthpiece 35. In some specific embodiments the body is further provided with a manual activation device 265, e.g. a button, switch, or touch sensor located on the outside of the body.

The control body 20 and cartomizer 30 may be detachable from one another by separating in a direction parallel to the longitudinal axis LA, as shown in FIG. 1, but are joined together when the device 10 is in use by a connection, indicated schematically in FIG. 1 as 25A and 25B, to provide mechanical and electrical connectivity between the control body 20 and the cartomizer 30. The electrical connector 25B on the control body 20 that is used to connect to the cartomizer 30 also serves as a socket for connecting a charging device (not shown) when the control body 20 is detached from the cartomizer 30. The other end of the charging device may be plugged into a USB socket to re-charge the cell in the control body 20 of the e-cigarette 10. In other implementations, a cable may be provided for direct connection between the electrical connector 25B on the control body 20 and a USB socket.

The electronic aerosol provision device 10 is provided with one or more holes (not shown in FIG. 1) for air inlets. These holes connect to an air passage through the electronic aerosol provision device 10 to the mouthpiece 35. When a user inhales through the mouthpiece 35, air is drawn into this air passage through the one or more air inlet holes, which are suitably located on the outside of the electronic aerosol provision device. When the heater is activated to vaporize the nicotine from the cartridge, the airflow passes through, and combines with, the generated vapor, and this combination of airflow and generated vapor then passes out of the mouthpiece 35 to be inhaled by a user. Except in single-use devices, the cartomizer 30 may be detached from the control body 20 and disposed of when the supply of liquid is exhausted (and replaced with another cartomizer if so desired).

In some cases, the electronic aerosol delivery device may comprise means to control aspects of the airflow in the system. A portion of the airflow pathway providing a fluid communication path between the mouthpiece 35 and one or more air inlet holes in the device 10 to may be provided with features which are movable to change the shape of the airflow pathway (e.g. the topology of the walls bounding the air flow path), and thereby change characteristics of airflow in the electronic aerosol provision device. For instance, movable features (such as valves, baffles or inlets) may enable modification of operating parameters such as the resistance to draw of the device 10, the degree of turbulence in the airflow pathway, the direction of airflow in the vicinity of aerosol generating component 365, and the condensation path distance between the aerosol generating component 365 and the mouthpiece 35. In some examples, the resistance to draw of the device can be modified by providing means to selectively open or close one or more air inlets configured to allow air into the air passage comprised in the device. For example, a slider may be provided on the outer housing of the device 10, configured to be moved to different positions (e.g. rotated about axis LA, or displaced along axis LA). The slider may be provided with one or more apertures configured to align with one or more air inlets when the slider is in a first position, and to occlude one or more air inlets when the slider is in a second position. Adjusting the position of the slider between the first and second positions can enable the degree of resistance to draw in the device to be adjusted by modifying the air inlet cross-section. Alternatively or in addition, one or more features may be provided within the airflow passage in the electronic aerosol provision device to adjust the resistance to draw. For example, an aperture such as mechanical iris may be disposed across an air pathway within the device 10. The shape and cross-sectional area of the aperture may be changed in order to modify the resistance to draw through the device. In examples of devices comprising a slider or an aperture, the resistance to draw may be controllable by control circuitry such as a control circuitry or ASIC as described further herein. In such examples, the aperture and/or slider may be actuated by an electromechanical actuator such as a linear or rotational actuator, and the actuator position controlled by the control circuitry to adjust the resistance to draw of the device according to approaches set out further herein. Other features may be included in the device to modify the airflow through the device, controlled by the control circuitry in a similar manner. For example, one or more moveable baffles, or a mechanical aperture, or one or more air inlets may be disposed in the air passage 335 at a position upstream of and in the vicinity of the aerosol generating component 365. These features may be moved into different positions to adjust the manner in which incident air impinges upon the aerosol generating component 365 when a user draws on the device. For example, one or more baffles may be moved to different angles relative to the axis LA to direct incident air more or less directly onto the aerosol generating component 365, thereby changing the velocity and turbulence of the air impinging the aerosol generating component. One or more air inlets in the vicinity of the aerosol generating component may be selectively opened and closed to supply additional inlet air upstream of the aerosol generating component 365, in order to change the turbulence and velocity of the airflow in the vicinity of the aerosol generating component and/or adjust the temperature of the airflow in the vicinity of the aerosol generating component. Changing the temperature, velocity and turbulence of the airflow in the vicinity of the aerosol generating component can enable adjustment of vapor condensation dynamics to modify the particle size of the aerosol provided by the device 10. For example, increasing the rate of cooling of vapor generated by an aerosol generating component such as a heater (via opening of air inlets upstream or downstream of the heater, or by increasing the turbulence downstream of the heater) may lead to an aerosol having an increased particle size.

It will be appreciated that the electronic aerosol provision device 10 shown in FIG. 1 is presented by way of example, and various other implementations can be adopted. For example, in some embodiments, the cartomizer 30 is provided as two separable components, namely a cartridge comprising the liquid reservoir and mouthpiece (which can be replaced when the liquid from the reservoir is exhausted), and an aerosol generating component comprising a heater (which is generally retained). As another example, the charging facility may connect to an additional or alternative power source, such as a car cigarette lighter.

FIG. 2 is a schematic (simplified) diagram of the control body 20 of the electronic aerosol provision device 10 of FIG. 1 in accordance with some embodiments of the disclosure. FIG. 2 can generally be regarded as a cross-section in a plane through the longitudinal axis LA of the electronic aerosol provision device 10. Note that various components and details of the body, e.g. such as wiring and more complex shaping, have been omitted from FIG. 2 for reasons of clarity.

The control body 20 includes a battery or cell 210 for powering the electronic aerosol provision device 10 in response to a user activation of the device. Additionally, the control body 20 includes control circuitry (not shown in FIG. 2), for example a chip such as an application specific integrated circuit (ASIC) or microcontroller, for controlling the electronic aerosol provision device 10. The microcontroller or ASIC includes a CPU or micro-processor. The operations of the CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required. The microcontroller also contains appropriate communications interfaces (and control software) for communicating as appropriate with other devices in the body 10. The control circuitry is further configured to monitor one or more operating parameters of the device (for instance via sensing of component states, such as the conditions of the battery 210 and the aerosol generator 365, and/or by counting device activations, device activation time, or device component lifespans) as set out further herein.

The control body 20 further includes a cap 225 to seal and protect the far (distal) end of the electronic aerosol provision device 10. Typically there is an air inlet hole provided in or adjacent to the cap 225 to allow air to enter the control body 20 when a user inhales on the mouthpiece 35. The control circuitry or ASIC may be positioned alongside or at one end of the battery 210. In some embodiments, the ASIC is attached to a sensor unit 215 to detect an inhalation on mouthpiece 35 (or alternatively the sensor unit 215 may be provided on the ASIC itself). An air path is provided from the air inlet through the electronic aerosol provision device, past the airflow sensor 215 and the heater (in the aerosol generating component or cartomizer 30), to the mouthpiece 35. Thus when a user inhales on the mouthpiece of the electronic aerosol provision device, the CPU detects such inhalation based on information from the airflow sensor 215, and provides power to the aerosol generating component 365.

At the opposite end of the control body 20 from the cap 225 is the connector 25B for joining the control body 20 to the cartomizer 30. The connector 25B provides mechanical and electrical connectivity between the control body 20 and the cartomizer 30. The connector 25B includes a body connector 240, which is metallic (silver- or gold-plated in some embodiments) to serve as one terminal for electrical connection (positive or negative) to the cartomizer 30. The connector 25B further includes an electrical contact 250 to provide a second terminal for electrical connection to the cartomizer 30 of opposite polarity to the first terminal, namely body connector 240. The electrical contact 250 is mounted on a coil spring 255. When the body 20 is attached to the cartomizer 30, the connector 25A on the cartomizer 30 pushes against the electrical contact 250 in such a manner as to compress the coil spring in an axial direction, i.e. in a direction parallel to (co-aligned with) the longitudinal axis LA. In view of the resilient nature of the spring 255, this compression biases the spring 255 to expand, which has the effect of pushing the electrical contact 250 firmly against connector 25A of the cartomizer 30, thereby helping to ensure good electrical connectivity between the control body 20 and the cartomizer 30. The body connector 240 and the electrical contact 250 are separated by a trestle 260, which is made of a non-conductor (such as plastic) to provide good insulation between the two electrical terminals. The trestle 260 is shaped to assist with the mutual mechanical engagement of connectors 25A and 25B.

As mentioned above, a button 265, which represents a form of manual activation device 265, may be located on the outer housing of the control body 20. The button 265 may be implemented using any appropriate mechanism which is operable to be manually activated by the user—for example, as a mechanical button or switch, a capacitive or resistive touch sensor, and so on. It will also be appreciated that the manual activation device 265 may be located on the outer housing of the cartomizer 30, rather than the outer housing of the control body 20, in which case, the manual activation device 265 may be attached to the ASIC via the connections 25A, 25B. The button 265 might also be located at the end of the control body 20, in place of (or in addition to) cap 225.

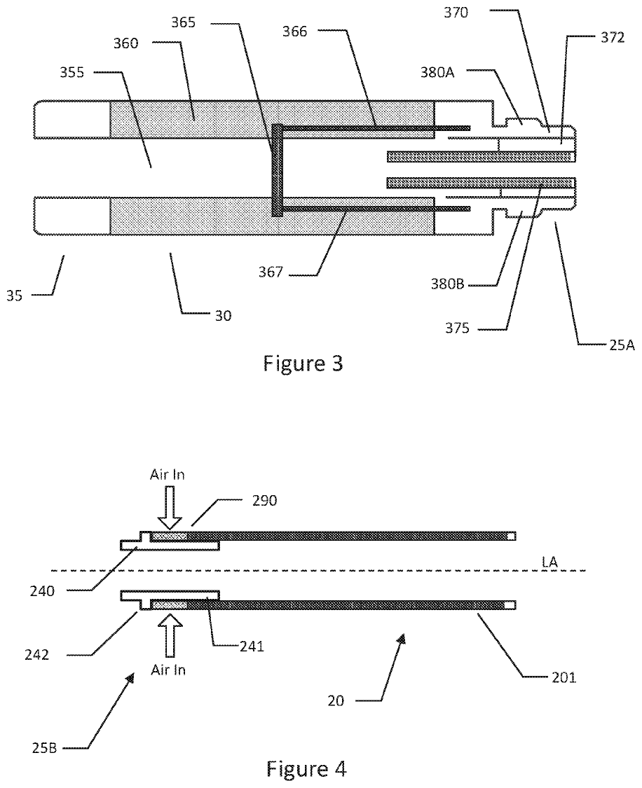

FIG. 3 is a schematic diagram of the cartomizer 30 of the electronic aerosol provision device 10 of FIG. 1 in accordance with some embodiments of the disclosure. FIG. 3 can generally be regarded as a cross-section in a plane through the longitudinal axis LA of the electronic aerosol provision device 10. Note that various components and details of the cartomizer 30, such as wiring and more complex shaping, have been omitted from FIG. 3 for reasons of clarity.

The cartomizer 30 includes an air passage 355 extending along the central (longitudinal) axis of the cartomizer 30 from the mouthpiece 35 to the connector 25A for joining the cartomizer 30 to the control body 20. One or more reservoirs of liquid 360 are provided around the air passage 335. The reservoir(s) 360 may be implemented, for example, by providing cotton or foam soaked in liquid, or may comprise a housing in which free liquid is held. The cartomizer 30 also includes one or more heaters 365 for heating liquid from reservoir 360 to generate vapor to flow through air passage 355, forming a condensation aerosol, and exiting the device through mouthpiece 35 in response to a user inhaling on the electronic aerosol provision device 10. The heater 365 is powered through lines 366 and 367, which are in turn connected to opposing polarities (positive and negative, or vice versa) of the battery 210 of the main control body 20 via connector 25A (the details of the wiring between the power lines 366 and 367 and connector 25A are omitted from FIG. 3).

The connector 25A includes an inner electrode 375, which may be silver-plated or made of some other suitable metal or conducting material. When the cartomizer 30 is connected to the control body 20, the inner electrode 375 contacts the electrical contact 250 of the control body 20 to provide a first electrical path between the cartomizer 30 and the control body 20. In particular, as the connectors 25A and 25B are engaged, the inner electrode 375 pushes against the electrical contact 250 so as to compress the coil spring 255, thereby helping to ensure good electrical contact between the inner electrode 375 and the electrical contact 250.

The inner electrode 375 is surrounded by an insulating ring 372, which may be made of plastic, rubber, silicone, or any other suitable material. The insulating ring is surrounded by the cartomizer connector 370, which may be silver-plated or made of some other suitable metal or conducting material. When the cartomizer 30 is connected to the control body 20, the cartomizer connector 370 contacts the body connector 240 of the control body 20 to provide a second electrical path between the cartomizer 30 and the control body 20. In other words, the inner electrode 375 and the cartomizer connector 370 serve as positive and negative terminals (or vice versa) for supplying power from the battery 210 in the control body 20 to the heater 365 in the cartomizer 30 via supply lines 366 and 367 as appropriate. Where a plurality of aerosol generating components 365 and/or pumping means are comprised in the electronic aerosol delivery device, a plurality of electrical connections may be formed between the cartomizer 30 and the control body 20 to provide for separate activation of individual aerosol generating components 365/pumping means.

The cartomizer connector 370 is provided with two lugs or tabs 380A, 380B, which extend in opposite directions away from the longitudinal axis of the electronic aerosol provision device 10. These tabs are used to provide a bayonet fitting in conjunction with the body connector 240 for connecting the cartomizer 30 to the control body 20. This bayonet fitting provides a secure and robust connection between the cartomizer 30 and the control body 20, so that the cartomizer and body are held in a fixed position relative to one another, with minimal wobble or flexing, and the likelihood of any accidental disconnection is very small. At the same time, the bayonet fitting provides simple and rapid connection and disconnection by an insertion followed by a rotation for connection, and a rotation (in the reverse direction) followed by withdrawal for disconnection. It will be appreciated that other embodiments may use a different form of connection between the control body 20 and the cartomizer 30, such as a snap fit, magnetic or a screw connection.

FIG. 4 is a schematic diagram of certain details of the connector 25B at the end of the control body 20 in accordance with some embodiments of the disclosure (but omitting for clarity most of the internal structure of the connector as shown in FIG. 2, such as trestle 260). In particular, FIG. 4 shows the external housing 201 of the control body 20, which generally has the form of a cylindrical tube. This external housing 201 may comprise, for example, an inner tube of metal with an outer covering of paper or similar. The external housing 201 may also comprise the manual activation device 265 (not shown in FIG. 4) so that the manual activation device 265 is easily accessible to the user.

The body connector 240 extends from this external housing 201 of the control body 20. The body connector 240 as shown in FIG. 4 comprises two main portions, a shaft portion 241 in the shape of a hollow cylindrical tube, which is sized to fit just inside the external housing 201 of the control body 20, and a lip portion 242 which is directed in a radially outward direction, away from the main longitudinal axis (LA) of the electronic aerosol provision device. Surrounding the shaft portion 241 of the body connector 240, where the shaft portion does not overlap with the external housing 201, is a collar or sleeve 290, which is again in a shape of a cylindrical tube. The collar 290 is retained between the lip portion 242 of the body connector 240 and the external housing 201 of the body, which together prevent movement of the collar 290 in an axial direction (i.e. parallel to axis LA). However, collar 290 is free to rotate around the shaft portion 241 (and hence also axis LA).

As mentioned above, the cap 225 is provided with an air inlet hole to allow air to flow when a user inhales on the mouthpiece 35. However, in some embodiments the majority of air that enters the device when a user inhales flows through collar 290 and body connector 240 as indicated by the two arrows in FIG. 4.

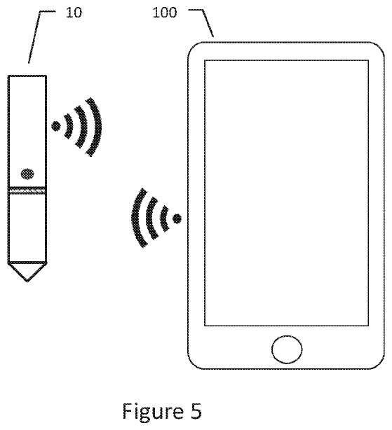

Referring now to FIG. 5, in an embodiment of the present disclosure a system to provide a more responsive electronic aerosol delivery device may comprise two components, such as an electronic aerosol delivery device 10 and an external computing device or server such as a mobile phone or similar device (such as a tablet) 100 operable to communicate with the electronic aerosol delivery device (for example to at least receive data from the electronic aerosol provision device), for example via Bluetooth®. In this case, the phone provides wider data gathering and processing capability and may interface via a data connection with the electronic aerosol delivery device to transmit and receive data. It will be appreciated in the present disclosure that functions described as being performed by the control circuitry of the electronic aerosol delivery device may be partially or fully performed by the external device 100. For example, the control circuitry may be configured to transmit data to the external device 100 which is processed by the external device 100 (for example, using a model as described further herein to determine control parameters to be used by the device on the basis of measurements of one or more operating parameters). Results of processing at the external device 100 may then be transmitted back to the electronic aerosol delivery device, and control parameters of the electronic aerosol delivery device modified by the control circuitry on the basis of said results.

However it will be appreciated that whilst the pairing of the electronic aerosol delivery device 10 with an external device 100 is likely, it is also envisaged that an electronic aerosol delivery device/electronic aerosol provision device with suitable control circuitry and/or user interface capabilities may implement approaches described further herein by itself.

The aerosol profile of an aerosol generated by an electronic aerosol delivery device may be influenced by a variety of factors. The aerosol profile of the aerosol may be considered to be defined at least in part by a plurality of characteristics of the aerosol which may be measurable, and/or may be sensed by the user. For example, aerosol characteristics may comprise parameters including the temperature, aerosol particle size distribution, mass loss of aerosolizable material per puff (or “DML”), concentration or amount of active material (e.g. nicotine) or flavoring per puff, of the aerosol generated by the electronic aerosol delivery device. Aerosol characteristics may also comprise characteristics such as the perceived ‘throat hit’ or satisfaction of the user, which may be based on other physically measurable characteristics. Characteristics of the aerosol may vary in dependence on operating parameters of the device. For example, degradation of components in the electronic aerosol delivery device (e.g. a reduction in the performance of the battery or aerosol generating component) may result in a change in one or more characteristics of the generated aerosol. Accordingly, operating parameter changes may cause the aerosol profile of aerosol generated by the electronic aerosol delivery device to change, even if control parameters of the device (i.e. those controllable by a user and/or control circuitry of the device) are unchanged. Accordingly, the aerosol profile of aerosols generated by the electronic aerosol delivery device may change over time without a user seeking to control said changes via adjustment of control parameters. This may lead to user dissatisfaction.

Accordingly, an electronic aerosol delivery system is provided comprising control circuitry configured to monitor at least one operating parameter of the electronic aerosol delivery system, to control at least one control parameter of the electronic aerosol delivery system to generate an aerosol having a first aerosol profile, to determine if one or more of the operating parameters changes or is likely to change, and to modify a control parameter of the electronic aerosol delivery system in response to such a determination. The decision as to how to modify a control parameter of the electronic aerosol delivery system can be taken so as to mitigate against a changes to the first aerosol profile resulting from a change in one or more operating parameters.

Therefore, in accordance with examples of the present disclosure, an electronic aerosol delivery device 10 is configured with one or more control parameters which can be adjusted to change the aerosol generating characteristics of the system. The control parameters may be directly adjustable by a user and/or may be set and modified by control circuitry. In general, control parameters determine aspects of device operation, and may comprise parameters relating to the supply of power to an aerosol generating component, parameters relating to the control of airflow in the aerosol delivery device, parameters relating to the supply of aerosolizable material to one or more aerosol generating components, or parameters relating other aspects of device operation. What is significant about the one or more control parameters is that they can be modified, for example by user inputs and/or by control circuitry and/or by a device 100 configured to communicate with the electronic aerosol delivery device via a wired or wireless connection as set out further herein. The one or more control parameters may be related to characteristics of an aerosol generated by the aerosol provision system, such that one or more characteristics of an aerosol generated by the aerosol provision system (and thus the aerosol profile of the aerosol) can be modified by changing one or more of the control parameters.

For example, a first set of control parameters may relate to supply of power to one or more aerosol generating components. For instance, in some examples the aerosol delivery device comprises an aerosol generating component in the form of a heater, and the temperature of the heater during aerosol generation can be controlled by adjusting the amount of power delivered to the heater. In some cases, this is achieved though pulse width modulation (PWM), wherein the duty cycle of the power supplied to the heater is adjusted by the control circuitry. The duty cycle may be controlled in part on the basis of a current output voltage of the battery, such that a consistent level of power to the heater per puff can be maintained as the voltage of the battery drops during use.

The supply of power to an aerosol generating component during a puff may also be controlled using other power supply parameters. For example, where the aerosol generating component is a heater, the power profile during a puff may be controlled to provide a pre-heating phase at a higher power for a first part of a puff (e.g. a fixed time), and then provide a heating phase at a lower power for a second part of the puff (e.g. for the remaining time until the end of the puff is determined). Providing a pre-heating phase at a high temperature in this manner may reduce the average particle size of the aerosol generated during the puff. As a further example of a power supply parameter, for a given amount of energy to be supplied during a puff, the duty cycle may be adjusted to provide shorter pulses of a higher power, or longer pulses of a lower power.

It will be appreciated these are only some examples of power supply parameters, and other may be implemented by the skilled person.

One or more power supply parameters may be set by a user according to their preferences, or be predetermined by the control circuitry, or automatically set by the control circuitry (or by an external device to which the aerosol delivery device has a data connection, for example, via an app running on a smartphone connected to the aerosol delivery device). In general, control parameters comprising parameters determining how power is supplied to an aerosol generating component will be set to specific values selected to target generation of an aerosol having certain physical characteristics. For example, a higher power may be selected to target a warmer aerosol, and a lower power may be selected to target a cooler aerosol. A higher power may be selected to target a more dense aerosol (e.g. in terms of volume of aerosolizable material per unit volume of aerosol delivered by the device, or mass of aerosolizable material aerosolized per puff), and a lower power may be selected to target a less dense aerosol. A higher power may be selected to target an aerosol particle size distribution with a greater proportion of larger particles, and a lower power may be selected to target an aerosol particle size distribution with a greater proportion of smaller particles. It will be appreciated that these relationships are exemplary, and that the relationship between power delivery parameters and specific characteristics of the aerosol generated by the device will be dependent on, for example, the specific configuration of a particular aerosol delivery device and other operating parameters of the device.

A second set of control parameters may relate to airflow in the aerosol delivery device. For instance, as set out further herein, the resistance to draw of the device may be modulated by one or more sliding elements and/or one or more mechanical iris elements and/or one or more moveably baffle elements as described further herein, which modify the cross-sectional area of a portion of an airflow path through the device (for instance the air inlet(s) or an air passage 335), enabling the flow rate (e.g. in term of 1/m) to be modified for a given suction applied at the mouthpiece (e.g. in terms of mmHg). Additionally or alternatively, the turbulence of airflow in the device may be modified by changing the positions of one or more moveable baffles or apertures in the device as set out further herein. For instance, baffles or apertures disposed in an airflow path may be adjusted to produce a venturi effect in a portion of the airflow path in the vicinity of the aerosol generating component, which may generally promote particle coalescence and lead to an aerosol particle size distribution with a greater proportion of larger particles. Additionally or alternatively, the direction and velocity of incident air arriving at the aerosol generating component may be modified by adjusting one or more baffles or apertures, and/or opening one or more air inlets. Increasing the velocity of air impinging the aerosol generating component and/or causing inlet air to impinge the aerosol generating component along an orientation more normal to the aerosol generating component surface may modify characteristics of the aerosol such as the particle size distribution. Additionally or alternatively, the temperature of airflow in the device may be modified. In some examples this can be achieved by placing a cooling element (for instance a Peltier element controlled by the control circuitry) upstream or downstream of the vaporizing element (e.g. incorporated into the wall of an airflow passage, or disposed within the cross-section of an airflow passage). In other examples, this can be achieved by selectively opening or closing one or more air inlets in the vicinity of the aerosol generating component to cool the aerosol. Adjusting the temperature of air in the vicinity of the aerosol generating component can be used to adjust the condensation rate of vapor produced by the aerosol generating component, and may thereby allow control of the particle size of the aerosol delivered to a user. For example, cooling the air in the vicinity of the aerosol generating component may generally lead to more rapid condensation of vapor and an aerosol particle size distribution with a greater proportion of larger particles.

One or more airflow parameters may be set by a user according to their preferences, or be predetermined by the control circuitry, or automatically set by the control circuitry (or an external device to which the aerosol delivery device has a data connection). In general, control parameters comprising parameters determining how air flows in the device will be set in order to target generation of an aerosol having certain physical characteristics. For example, a higher resistance to draw may be selected to target a more dense aerosol, and a lower resistance to draw may be selected to target a less dense aerosol. A higher resistance to draw may be selected to target a lower concentration of aerosolizable material delivered per puff, and a lower resistance to draw may be selected target a lower concentration of aerosolizable material delivered per puff. A greater degree of turbulence in the vicinity of the vaporizing element may be selected to target an aerosol particle size distribution with a greater proportion of larger particles, and a lower power may be selected to target an aerosol particle size distribution with a greater proportion of smaller particles. A greater rate of air/vapor/aerosol cooling in the vicinity of the vaporizing element may be selected to target an aerosol particle size distribution with a greater proportion of larger particles, and a lower rate of air/vapor/aerosol cooling may be selected to target an aerosol particle size distribution with a greater proportion of smaller particles. It will be appreciated that these relationships are exemplary, and that the relationship between airflow parameters and specific characteristics of the aerosol generated by the device will be dependent on, for example, the specific configuration of a particular aerosol delivery device and other operating parameters of the device.

A third set of control parameters may relate to the supply of aerosolizable material to one or more aerosol generating components. For instance, as set out further herein, the rate with which an aerosolizable material is provided to a aerosol generating component may be controlled by, for example, controlling a rate of pumping of a pumping element (e.g. a piezoelectric pump) used to supply liquid from a reservoir to a aerosol generating component, or controlling the pressure within a reservoir, or changing the size of an aperture used to supply liquid from a reservoir to a transport element such as a wick, or controlling the power delivered to a heater by the control circuitry. As set out further herein, in some examples a plurality of reservoirs may be provided to enable a plurality of aerosolizable materials to be simultaneously aerosolized to produce an aerosol which comprises a mixture of the plurality of aerosolizable materials. For instance, an electronic aerosol provision device may comprise a first reservoir containing a first aerosolizable material, and a second reservoir containing a second aerosolizable material. In a first example, aerosolizable material may be provided from each reservoir to a shared aerosol generating component, and means are provided as set out further herein to control the rates with which aerosolizable material is provided from the first and second reservoirs respectively. In this manner, by adjusting the supply rates of the first and second aerosolizable materials during aerosol generation, the proportions of the first and second aerosolizable materials in the resulting aerosol can be controlled, for instance, by the control circuitry. In a second example, the first reservoir is connected to a first aerosol generating component, and the second reservoir is connected to a second aerosol generating component. The connections may comprise wicking elements which passively supply liquid from the reservoirs to the respective aerosol generating components via capillary action, or may comprise active means by which the rate of supply can be controlled (e.g. pumping means or modifiable apertures). By providing a separate aerosol generating component for each reservoir (and thus for aerosolization of each of the first and second aerosolizable materials), the proportions of the first and second aerosolizable materials in an aerosol generated by the device can be controlled by adjusting the rate of supply of aerosolizable material to each aerosol generating component, and/or the power supply parameters associated with each aerosol generating component, and/or the airflow parameters associated with the airflow path comprising each aerosol generating component.

One or more aerosolizable material supply parameters may be set by a user according to their preferences, or be predetermined by the control circuitry, or automatically set by the control circuitry (or an external device to which the aerosol delivery device has a data connection). In general, control parameters comprising parameters determining the rates of aerosolization of one or more aerosolizable materials will be set in order to target generation of an aerosol having certain physical characteristics. For example, a first reservoir may contain aerosolizable material comprising a first concentration of an active material and/or an aerosol forming material and/or one or more functional materials, and a second reservoir may contain aerosolizable material comprising a second concentration of an active material and/or an aerosol forming material and/or one or more functional materials. For instance, the first reservoir may contain aerosolizable material with a first concentration of nicotine, and the second reservoir may contain aerosolizable material with a second concentration of nicotine. The relative aerosolization rates of the first and second aerosolizable materials can be controlled via adjustment of one or more parameters controlling the rates of supply of the first and second aerosolizable materials to one or more aerosol generating components and/or via adjustment of power control parameters of first and second aerosol generating components used to respectively vaporize the first and second aerosolizable materials. In this manner the nicotine concentration of the resulting aerosol generated by the device can be adjusted, in terms of nicotine per unit volume of aerosolizable material in the aerosol, and/or in terms of nicotine per unit volume of aerosol. In some examples, the first and second reservoirs respectively may contain first and second aerosolizable materials comprising different aerosol forming materials. For instance, the first aerosolizable material may comprise vegetable glycerine (VG), and the second aerosolizable material may comprise propylene glycol (PG). Adjusting the relative aerosolization rates of the two aerosolizable materials according to the approaches set out herein enables aerosols with different ratios of VG and PG to be generated. A greater proportion of PG may be selected to target a less visible aerosol, and/or an aerosol particle size distribution with a greater proportion of larger particles, and/or an aerosol with a more pronounced throat hit for the user. A greater proportion of VG may be selected to target a less visible aerosol and/or an aerosol particle size distribution with a greater proportion of smaller particles, and/or an aerosol with a less pronounced throat hit for the user. It will be appreciated that these relationships are exemplary, and that the relationship aerosolizable material supply parameters and specific characteristics of the aerosol generated by the device will be dependent on, for example, the specific configuration of a particular aerosol delivery device and other operating parameters of the device. In the foregoing it will be appreciated that any number of reservoirs may be provided, configured to contain aerosolizable materials which may comprise any suitable composition in terms of selection of and proportion of active material (e.g. medicament/nicotine), olfactory component (e.g. flavoring material), aerosol forming material or functional material.

A number of control parameters have therefore been described which may be modulated to change one or more characteristics of aerosol generated by the aerosol delivery device. Accordingly, by setting one or more control parameters to specific first values, the system can be configured to generate an aerosol during one or more puffs having a first aerosol profile. It will be appreciated that an aerosol profile comprises one or more characteristics of the aerosol which may relate to both its physical properties and one or more sensory/pharmacological responses elicited in a user by the aerosol. Thus for example, a first aerosol profile for an aerosol generated during a first puff may comprise a particular particle size distribution, a particular aerosol temperature, a particular visibility of the aerosol, and a particular composition of the aerosol. The composition of the aerosol may be expressed in either terms of the ratios of different active materials and/or aerosol forming materials and/or functional materials such as flavorings; or in terms of the concentrations of such materials in the aerosol, expressed either as a concentration of one or more materials per unit volume of aerosol, or as a concentration of one or more materials per unit volume of aerosolized material. The first aerosol profile may further comprise a particular physiological effect on the user, for instance a particular ‘throat hit’, or a particular dose of an active ingredient per puff.

The aerosol delivery device is further configured to monitor one or more operating parameters of the device. Operating parameters of the device will be understood to comprise parameters which influence the operation of the device (e.g. in terms of influencing one or more characteristics of an aerosol generated by the device), and in this regard may comprise parameters directly relating to physical characteristics of the device itself and of its components, parameters relating to the use of the device (e.g. draw strength), and parameters relating to environmental conditions (e.g. the temperature, pressure and humidity of inlet air). It will be appreciated that operating parameters of the device may also comprise control parameters as described herein which may be modified by a user and/or by control circuitry. For example, operating parameters may comprise power supply parameters, airflow parameters, and aerosolizable material supply parameters which can be adjusted by the user, and/or by the control circuitry, and/or by an external device with a data connection to the aerosol delivery device (e.g. a smartphone running an app, or a server).

According to examples of the present disclosure, monitoring of operating parameters comprises monitoring of one or more control parameters set by a user, or determined automatically by control circuitry, or determined by an external device which is configured to communicate data with the aerosol delivery device. For instance, the control circuitry may monitor a power level to be supplied to the aerosol generating component, a pressure in an airflow path during a puff on the device (as indicated, for instance, by a signal from a pressure sensor 215), or a current position of an aperture, slider or baffle used to control the resistance to draw of the device. Monitoring may be carried out via sensing, or via a user inputting a value corresponding to a control parameter via a user input device. For instance, the resistance to draw of the device may be set manually by the user using a slider, and the user can indicate to the control circuitry the current slider position (and therefore the current resistance to draw) using one or more buttons on the device or using an interface on an external device with a data connection to the aerosol delivery device. Alternatively in this example, the resistance to draw may be inferred from a signal received by control circuitry from a puff sensor, or by directly sensing the slider position, or if the slider is automatically actuated by the device, by determining a parameter indicating the current demand position of the slider.

Operating parameters may comprise other parameters associated with the device which are not directly under the control of the control circuitry and/or a user. For example, the current condition of the battery may be represented by one or more operating parameters (inferred, for instance, from the number of charge and discharge cycles). The present or peak maximal power and voltage outputs of the battery may comprise operating parameters. The physical condition of an aerosol generating component (and/or failure state of a aerosol generating component) may be represented by an operating parameter (inferred, for example, by resistance measurement of an aerosol generating component comprising a heater, and/or determining the number of aerosol generating component activations or the total activation time). The operational (or failure) state of one or more components may be represented by operating parameters, for instance the peak flow rate and/or failure state of one or more pumps used to supply aerosolizable material for vaporization may be represented by operating parameters. Thus the control circuitry may monitor various operating parameters via direct sensing (for example, through airflow sensing; temperature sensing; humidity sensing; or circuit checks based on short-circuit, low-load or open-circuit measurements of the aerosol generating component, or of one or more aerosolizable material pumps, or of one or more actuators used to control airflow). Said monitoring may comprise both instantaneous determination of one or more present states relating to the device and its use, and also prediction of the future state of the device and its use. For instance, future changes in one or more operating parameters may be predicted by the control circuitry and/or an external device which is configured to communicate data with the aerosol delivery device. This may be carried out on the basis of comparing current operating parameter values and/or time-resolved operating parameter measurements with previously acquired data indicating how various operating parameters vary with respect to device usage, and estimating future parameter value changes on this basis. For example, monitoring data of the number of charge and discharge cycles of the battery may be compared with experimentally derived data linking the decline in peak power output with number of charge and discharge cycles, in order to determine the peak power output at a future point in time, based on a usual number of charge and discharge cycles per unit time (e.g. per day).

The control circuitry may therefore determine that an operating parameter of the device has changed according to any suitable approach. For example, the control circuitry may continuously monitor one or more sensors, or monitor one or more sensors during a puff, or at the beginning of a puff (for instance as soon as an activation signal from a button or puff sensor is received by the control circuitry). A measured value from a sensor may be compared to a predetermined threshold value, or to a previously measured value (or an averaged value such as a time-average).

It will be appreciated that changes in one or more operating parameters of the aerosol provision system may lead to changes in the aerosol profile of an aerosol generated by the aerosol provision system. This may be considered to be disadvantageous. For example, a user of an aerosol delivery device will generally set one or more control parameters as set out further herein in order to target generation of an aerosol having a first aerosol profile which is desirable to that particular user. Thus during a first puff, an aerosol generated by the aerosol delivery device on the basis of a first set of control parameter values will have a first aerosol profile (e.g. a first set of physical characteristics and/or sensory characteristics and/or pharmacological characteristics). The first control parameter values may be default values associated with the device (e.g. set in manufacture), and/or they may be input by a user using one or more input buttons or, for example, by an app associated with an external device such as a smartphone with which the aerosol delivery device can establish a data connection, and/or they may be set in an automated manner by control circuitry or an external device (e.g. a smartphone or server). In the latter cases, the control circuitry may determine values for one or more control parameters based on the user selecting a particular user profile, or the control circuitry (or an external device or server) may analyze usage of the device and determine a set of control parameter values to use based on, for example, matching monitored user behavior with one or more predefined usage profiles, and determining to use a set of control parameters associated with said usage profile. However if following the first puff, one or more operating parameters of the aerosol delivery device change, an aerosol generated in a subsequent puff may have an aerosol profile which is different to the first aerosol profile (e.g. in terms of one or more aerosol characteristics having changed). This may lead to user dissatisfaction. For instance, if between a first puff and a subsequent puff the battery output voltage drops, the device may not be able to supply the same level of power to the heater in the subsequent puff as was supplied during the first puff. This may lead to a reduction in the particle size of the aerosol, and a corresponding difference in the ‘throat hit’ provided by the aerosol, and/or to a reduction in the concentration of certain aerosol constituents in the aerosol, for instance, the concentration of nicotine per unit volume of aerosol.

Accordingly, an electronic aerosol delivery system is provided in which control circuitry is configured to modify a control parameter of the system in response to determining one or more of the operating parameters have changed or are predicted to change at a future point in time. In general, a determined change in one or more operating parameters between a first and subsequent puff will be associated with a change in a characteristic of a first aerosol profile of aerosol generated during the first puff, such that the change in the one or more operating parameters between the first and subsequent puffs would lead to generation of an aerosol having a second, different aerosol profile during the subsequent puff. Accordingly, the control circuitry is configured, in response to determining one or more operating parameters have changed, to modify one or more control parameters of the system in a manner which mitigates against an actual or predicted change in one or more characteristics of the first aerosol profile due to the change in the one or more operating parameters.

This mitigation may be carried out in a number of ways.

According to some examples, the control circuitry, on determining an operating parameter of the aerosol delivery device has changed, may be able to control a control parameter of the device to mitigate directly against the change in operating parameter by restoring the value of the operating parameter during a subsequent puff to its value in the first puff. For instance, if in a first puff the aerosol generating component is operated at a first power level set by the user, and the control circuitry determines that subsequent to the first puff, the output voltage of the battery has decreased, the control circuitry may be configured to adjust the duty cycle of a PWM scheme used to deliver power to the aerosol generating component (e.g. by increasing the on pulse length) in order to deliver the same level of power to the aerosol generating component in a subsequent puff to that delivered in the first puff. Accordingly, it may be possible to generate an aerosol in the subsequent puff having a second aerosol profile which matches a first aerosol profile of aerosol generated during the first puff. Approaches described herein may be applied to these circumstances, wherein a change in an operating parameter can be mitigated directly via one or more control parameters, in order to, in effect, reverse the change in the operating parameter.

However, in other instances, it will not be possible to adjust a control parameter of the device to directly mitigate against a change in one or more operating parameters determined by the control circuitry. For instance, if in a first puff, a first level of power is supplied to the aerosol generating component using a duty cycle of 100% (i.e. the peak available power output of the battery is supplied to the aerosol generating component), and subsequent to the first puff the output voltage of the battery decreases (for instance due to discharging or battery degradation), it may not be possible to supply the same amount of power to the aerosol generating component in a subsequent puff as was supplied in the first puff. Accordingly the control circuitry is configured to establish, based on determining that an operating parameter of the device has changed subsequent to a first puff, how to change one or more control parameters of the device to mitigate against a resulting change in the aerosol profile of an aerosol generated during a second puff.

According to examples of the present disclosure, the control circuitry is configured to select one or more control parameters to modify, and determines a manner in which to carry out said modification (e.g. in terms of how to change each parameter), on the basis of a model describing the relationships between one or more operating/control parameters of the device and one or more characteristics of an aerosol generated by the device, and/or on the basis of a model describing the relationships between one or more operating parameters of the device and one or more control parameters of the device. Such a model may be parameterized by data derived from mathematical modelling and/or experimentation, and/or by usage data describing how one or more users modify the control parameters of the device in response to changes in operating parameters.

For example, data describing the relationships between operating parameters (including control parameters) and aerosol characteristics of the aerosol generated by the device, may be generated experimentally. A specific aerosol delivery device can be attached to an aerosol analyzer configured to provide data on the aerosol profile of an aerosol generated by the aerosol delivery device. A suitable analyzer in this regard might be an aerosol analyzer, such as a particle size analyzer (e.g. Spraytec laser diffraction system from Malvern, UK), which is able to assess various aerosol characteristics, such as particle size distribution. Other suitable analyzers may determine aerosol constituents, and may be comprised of a smoke engine (such as that available from Vitrocell®, Germany) equipped with an impinger able to trap aerosol constituents which can then be analyzed to determine quantities etc. Accordingly the aerosol analyzer may be configured to apply a certain negative pressure on the mouthpiece of the device for a certain time, simulating a puff, and measure characteristics of an aerosol generated device during the puff. Any suitable aerosol characteristics known to the skilled person may be measured by the aerosol analyzer. By systematically adjusting control parameters and/or operating parameters of the aerosol delivery device and analyzing one or more characteristics of the resulting aerosol for each combination of control and/or operating parameters, data can be acquired describing how the aerosol profile of aerosol generated by the aerosol delivery device changes with respect to different permutations of the plurality of control and/or operating parameters.

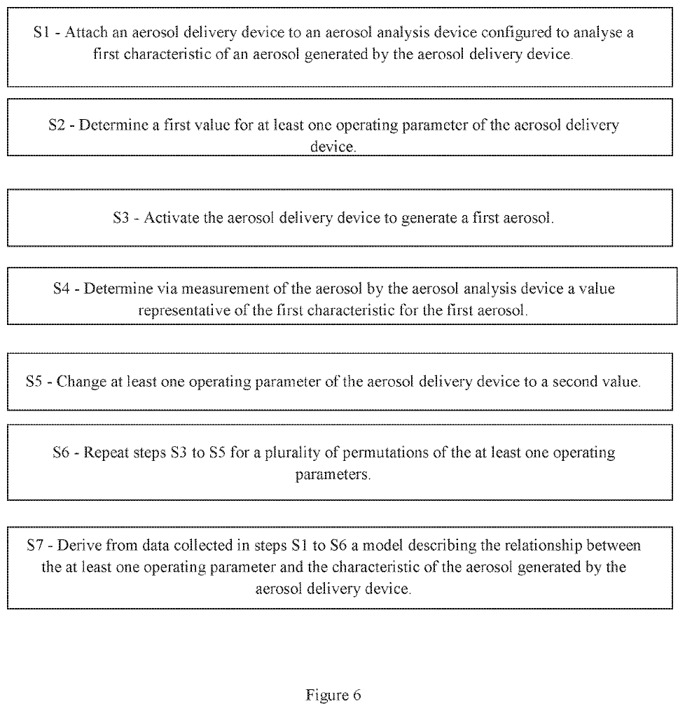

FIG. 6 shows in schematic form a method which can be used to generate data to be used for parameterizing a model as described further herein. According to S1, an aerosol delivery device is attached to an aerosol analysis device configured to analyze a first characteristic of an aerosol generated by the aerosol delivery device. The first characteristic may be, for example, an aerosol density characteristic, an aerosol particle size characteristic, an active material concentration characteristic, parameters including the temperature, a mass loss of aerosolizable material per puff (or “DML”) characteristic, or any other aerosol characteristic known to the skilled person and measurable using an aerosol analysis device. A plurality of characteristics may be measured. According to S2, a first value is determined for a first value for at least one operating parameter of the aerosol delivery device. This may comprise setting a control parameter, or measuring an operating parameter of the device. A plurality of operating parameters may be so determined. According to S3, the aerosol delivery device is activated to generate a first aerosol, which is passed into the aerosol analysis device. According to S4, the first aerosol is analyzed by the aerosol analysis device to determine a value representative of the first characteristic for the first aerosol. Values may also be determined which are representative of one or more other characteristics of the aerosol. According to S5, at least one operating parameter of the aerosol delivery device is set to a second value different from a first value associated with the analysis of the first aerosol by the device. The value may be set by determining a set of n increments (for example 10) spanning a possible range of values of the operating parameter, and incrementing from a value n used to generate the first aerosol to a value n+1. According to a plurality of operations at S6, S3 to S5 are repeated for a plurality of permutations of the at least one operating parameter. For example, values representative of one or more characteristics may be determined for aerosols generated for every permutation of the set of operating parameter values. According to S7, data collected in S1 to S6 are used to derive a model describing the relationship between the at least one operating parameter and the characteristic of the aerosol generated by the aerosol delivery device.

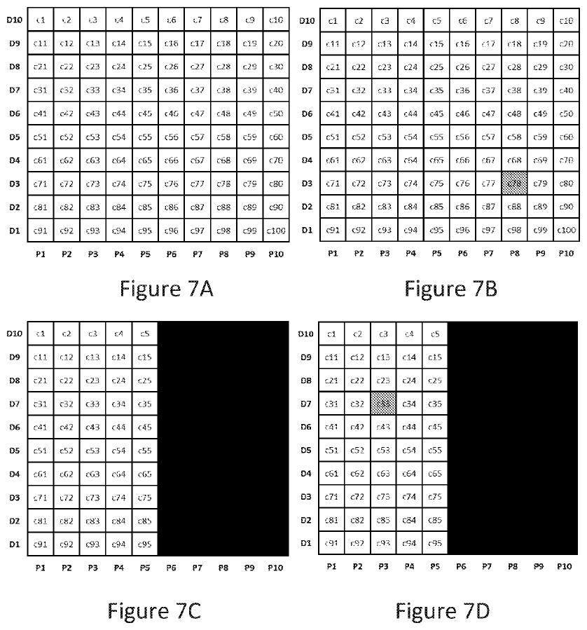

FIGS. 7A to 7D schematically show an approach to selection of control parameter values for an aerosol delivery device which can be used to mitigate against changes in aerosol characteristics caused by changes in one or more operating characteristics determined by the control circuitry. FIG. 7A shows in highly schematic form an example model which can be generated from data collected according to the approach set out in FIG. 6. The model shown in FIG. 7A comprises a matrix of aerosol characteristic values (c) corresponding to different combinations of two control parameters (P, D). In one example, the aerosol characteristic values c correspond to aerosol particle size values (e.g. median mass aerosol diameter (MMAD) values), the control parameter P corresponds to the power applied to the aerosol generating component, and D corresponds to the resistance to draw (e.g. the cross-sectional area of the air inlet(s) of the device). The values c1 to c100 can be determined by performing aerosol analysis of aerosol generated by the device for each permutation of power values P1 to P10 and resistance to draw values D1 to D10. The operating parameters may be discretized across the available range (e.g. P1 to P10 may represent evenly spaced power values between the minimum and maximum values characteristic of the device in the as-manufactured state, and may correspond to discrete power control parameters selectable by the user).

The model represented by FIG. 7A therefore represents an empirically derived relationship between two operating parameters and an aerosol characteristic. It will be appreciated that the selection of operating parameters and aerosol characteristic are arbitrary, and may comprise any of the examples described further herein. In addition, though a two-dimensional model has been described for simplicity of representation, it will be appreciated the model may comprise any number of operating and control characteristics, and the approach described herein may therefore be generalized to any dimension. Furthermore, a plurality of n models may be generated, where each of the n models describes how a different one of n aerosol characteristics varies as a function of different operating parameter values. It will be appreciated that this approach can be generalized to include operating parameters which are monitored by the control circuitry but not under the direct control of the control circuitry, and any number of operating parameters may be used to generate the one or more models. The one or models may be referred to as model data, which once derived for an aerosol delivery device may be stored on control circuitry associated with the aerosol delivery device, or stored on an external device or server with which the aerosol delivery device has a data connection.

Obtaining one or more models describing how one or more aerosol characteristics vary with different operating parameter values provides a means for the control circuitry to determine how to modify control parameters in response to a determined change in an operating parameter, in order to mitigate against changes in one or more aerosol characteristics. For instance, the model represented by FIG. 7A represents the relationship between particle size of the aerosol and the heater power and resistance to draw of the aerosol delivery device. FIG. 7B shows schematically a situation during a first puff, during which the heater power is at a value of P8, and the resistance to draw is at a value of D3. The control circuitry correspondingly determines from the model that the particle size of the aerosol generated during the first puff takes a value of c78, indicated by shading. The actual values of P8, D3 and c78 are not of particular relevance to this example, and will depend on the specific device and the empirical approach used to determine the model data. In this example, it will be assumed that subsequent to the first puff, the peak power which can be supplied to the heater decreases. The reason for this decrease is not of particular relevance, and could be due, for example, to discharging of the battery, damage to the battery, or through an increase in the number of charging/discharging cycles. The control circuitry determines that the peak power available to supply to the heater has dropped from the value P10 to the value P5. Accordingly, the portion of the operational envelope of the device represented by the region of the model shown in FIG. 7A corresponding to power values of P>P5 is no longer accessible. This scenario is represented by FIG. 7C, which shows the region of the model corresponding to the unavailable portion of the operating envelope blacked out. This unavailable region includes the control value P8 which was used during the first puff. Accordingly, the control circuitry determines a new set of control parameters P and D to be used to generate aerosol in a subsequent puff, doing so in a manner which seeks to minimize the change in the characteristic c between the first and subsequent puffs. Thus the control circuitry determines the available portion of the model, taking into account the determination of the change in the operating parameter. In the example shown in FIG. 7C, this comprises determining that power values equal to and lower than the measured peak power output of the battery (e.g. P1 to P5) are available for selection (i.e. the non-blacked-out-region of the operating parameter space), and determining that all the resistance to draw values (e.g. D1 to D10) are available for selection. Having established the range of the parameter space which is available, the control circuitry is configured in this example to search for a value of c in the available portion of the model which matches or is as close as possible to the value during the first puff (e.g. c78). This may be achieved by comparing the value c78 to each of the values of c in the available portion of the model, and finding the value of c which minimizes the difference with the value associated with the first puff. FIG. 7D shows an example in which the control circuitry has determined that characteristic value c33 is the closest match to the value c78 associated with the first puff. Accordingly, the control circuitry determines to set the power in a subsequent puff to P3 and the resistance to draw to D7, in order to generate a second aerosol during a second puff with a particle size c33 which minimizes the change in particle size between the aerosols generated in the first and subsequent puffs. In the foregoing, it will be appreciated that any combination of operating parameters may be used, and that not all the operating parameters necessarily comprise control parameters, provided at least one control parameter is represented in the model, enabling the control circuitry to determine a means to adjust the characteristic of the aerosol in response to determining a change in one or more operating parameters.

Though the examples shown schematically in FIGS. 7A to 7D describe a situation in which a model is used to mitigate against changes in particle size (i.e. c is a particle size parameter), it will be appreciated that some aerosol characteristics may be more desirable to a certain user than others. For example, to some users, maintaining a consistent aerosol particle size distribution is considered particularly important (for example, to target a consistent ‘throat hit’ or ‘mouth feel’. To some users, maintaining a consistent concentration of an active material (such as nicotine) is considered particularly important. To some users, maintaining a consistent aerosol density or aerosol temperature is considered particularly important. Conversely, to some users, certain characteristics may be less important, in the sense that the user is more willing to tolerate changes in said characteristics resulting from changes in operating parameters of the device. Accordingly, the control circuitry, on determining an operating parameter of the system has changed, may be configured to control one or more control parameters to mitigate against changes in the aerosol profile of an aerosol generated by device, doing so in a manner which takes into account a prioritization of certain aerosol characteristics. It will be appreciated that changing control parameters of the device may influence different ones of a plurality of aerosol characteristics of the device in different ways. Accordingly, if the control circuitry adjusts a control parameter following a first puff to seek to minimize a change in a first aerosol characteristic due to a change in an operating parameters, this may cause a second aerosol characteristic to change away from its value during a first puff. Accordingly, when an operating parameter of the system changes between a first and subsequent puff, it may not be possible for the control circuitry to control the available control parameters such that the aerosol profile of aerosol generated by the system is unchanged between the first and second puffs. Accordingly, it will be necessary in some instances to trade off different aerosol characteristics against each other, such that mitigating action taken by the control circuitry seeks to minimize changes in the characteristics which are most important to a user. Thus where model data for the aerosol delivery device comprises separate models for different aerosol characteristics, the control circuitry may select control parameters in response to a change in an operating parameter by first selecting a model which corresponds to a prioritized characteristic. Accordingly, a plurality of modelled characteristics may be arranged in a priority order by the control circuitry, such that the control circuitry will seek to mitigate against changes in one or more operating parameters of the aerosol delivery device so as to minimize the change to one or more prioritized characteristic. A priority listing of characteristics may be pre-set on the aerosol delivery device, or may be set by the user, or may be determined by the control circuitry on the basis of monitoring usage data.

In some examples, the control circuitry is not configured to modify the control parameters solely on the basis of seeking to minimize the change in an individual aerosol characteristic (e.g. the most highly prioritized characteristic), but is instead configured to take a plurality of modelled aerosol characteristics into account in determining how to change one or more control parameters in response to determining one or more operating parameters of the aerosol delivery device have changed. For instance, the control circuitry may seek to find permutations of one or more control parameters which minimize the value of a total difference parameter. For instance, for a plurality of models such as the model shown in FIG. 7A, where each model is associated with a different aerosol characteristic c, a difference parameter can be determined for each permutation of operating parameters (e.g. each permutation of P and D in FIG. 7A), wherein the difference parameter for each permutation is the difference between the corresponding value of c and the value of c during a first puff (e.g. the difference between each of the values c1 to c100, and the initial value c78 in FIG. 7A). Summing the values of the difference parameters across the plurality of models returns a total difference parameter for each permutation of operating parameters which represents how much the entire aerosol profile is likely to change by selecting said permutation of operating parameters for a subsequent puff. The total difference parameter for each permutation of operating parameters may be stored in a multi-dimensional matrix such as the two-dimensional matrix shown in FIG. 7A. This matrix can be considered to be a model of how much the entire aerosol profile (e.g. comprising all the modelled characteristics) varies with respect to changes in the values of one or more operating parameters. Using such a model to select a permutation of operating parameters to use for mitigating against a change in the aerosol profile can then proceed according to the approach described in relation to FIGS. 7A to 7D.

A priority ranking of aerosol characteristics may be used to weight how models of individual aerosol characteristics contribute to the determination of control parameters to use for mitigating against changes to the aerosol profile of aerosol generated by the device. For instance, in the summing of c values across the plurality of models for the plurality of modelled characteristics, the value of c from each model may be scaled by a coefficient associated with said model prior to summation, where the value of the coefficient is given a larger value if the given modelled characteristic is considered to have a higher priority. Thus if nicotine concentration is a particularly important aerosol characteristic for a user, the c values from the nicotine concentration model may be given a comparatively large coefficient in the summation of c values across the characteristics. The weighting values for each characteristic may be set by a user, or set by control circuitry in response to a user providing a ranking of different aerosol characteristics (for instance via an input device on the aerosol delivery device, or via an app running on an external device connected to the aerosol delivery device).

It will be appreciated that a model used to mitigate against changes in one or more aerosol, characteristics may comprise operating parameters which are under the control of the control circuitry and/or a user (i.e. they are also control parameters), and others which are not. Based on the monitoring of operating parameters which are not under the control of the control circuitry and/or a user, the control circuitry can determine portions of the parameter space of one or more models which are available for parameter selection. For example, portions of the modelled parameter space which are outside of the current value or range of values of a given operating parameter may be ignored by the control circuitry when selecting a candidate permutation of control parameters. Thus the measured values of one or more operating parameters can be used to constrain the selection of control parameters.

Having determined a permutation of control parameters which minimizes the change in one or more aerosol characteristics between a first puff and a subsequent puff, the control circuitry is further configured to modify said control parameters prior to the subsequent puff. This may be achieved by automatically adjusting one or more control parameters according to approaches as set out further herein, or indicating to a user via a display, haptic indicator or audible indication that one or more control parameters should be set to certain values. This may particularly be the case if one or more of the control parameters are controllable using manual means which are not under the direct control of the control circuitry. For example, the control circuitry may indicate to the user that the resistance to draw should be modified using a mechanical slider or rotating collar as set out further herein.

It will be appreciated that in some instances the control circuitry may determine using the model that one or more components of the aerosol delivery device should be cleaned, serviced or replaced in order to mitigate against a change in aerosol profile due to a change in operating characteristics of the device.

The foregoing description has set out examples in which the control circuitry, having determined a change in an operating parameter of the aerosol delivery device, determines how to change one or more control parameters of the aerosol delivery device so as to mitigate against changes to the aerosol profile of aerosol generated by the device resulting from the change in the operating parameter(s), and does so on the basis of model data representing how one or more aerosol characteristics vary with respect to a plurality of operating parameters. Though examples in the foregoing description have described approaches in which the model data comprises n-dimensional arrays providing aerosol characteristic values determined via modelling or experimentation for each of n operating parameters, it will be appreciated that other approaches can be taken. For example, machine learning approaches can be used to determine how to modify one or more control parameters so as to minimize a change in the aerosol profile of aerosol generated by the device following a change in one or more operating parameters. In one embodiment, a classifier (such as a convolutional neural network) is set up which has as an output a vector of control parameters for the aerosol delivery device, and takes as an input a vector of values indicating changes to one or more operating parameters of the aerosol delivery device. The classifier may be trained using data representing what control parameters have been set by a user in response to a given change in one or more operating parameters, in order to mitigate against changes in certain aerosol characteristics. Thus usage data collected for an individual user, or usage data collected for a plurality of users having similar usage profiles can be used as training data used to train the classifier. Once the neural network is trained, a change in one or more operating parameters can be fed into the input, and the control parameter values to be used for a subsequent puff can be returned at the output by running the classifier. It will be appreciated that such a classifier may be run on the control circuitry, or on an external device such as a server which has a data connection with the aerosol delivery device.

In the foregoing it will be appreciated that references to control circuitry determining an operating parameter has changed can refer also to control circuitry predicting or estimating that an operating parameter will change. Accordingly the determination as to how to modify the control parameters and optionally the actual modification of the control parameters can be carried out prior to an actual change in said operating parameter(s) being determined, so as to pre-emptively mitigate against a predicted change in one or more operating parameters of the aerosol delivery device.

In the foregoing it will be appreciated that functions herein attributed to the control circuitry may be carried out by an external device which has a data connection with the aerosol delivery device. For example, data indicating a change in one or more operating parameters of the system may be transmitted to a device such as a smartphone, or to an external server, via a wired or wireless connection. Processing to determine how to modify one or more control parameters to mitigate against a change in one or more characteristics of aerosol generated by the system as a result of the change in the operating parameter(s) may be carried out partially or entirely by said external device. The external device may then transmit back to the aerosol delivery device an indication of how to modify one or more control parameters of the device.

In the foregoing it will be appreciated that reference herein to the control circuitry modifying one or more control parameter in order to mitigate against a change in one or more aerosol characteristics as a result of one or more changes in operating parameters may refer to providing an indication to a user to modify an aspect of device operation. For example, one or more control parameters of the device may not be directly under the control of the control circuitry, but are able to be manually adjusted by the user (e.g. a manual slider or control ring may be used to control airflow or aerosolizable liquid flow in the device, one or more cartridges in the device may be changed, or a aerosol generating component in the device may be replaced or cleaned). If the control circuitry determines a control parameter should be modified which is not under direct control of the control circuitry, but is able to be manually adjusted by the user, then the control circuitry may indicate via appropriate indicating means that the user should adjust one or more of said control parameters in a particular way. For instance an indication may be provided to the user to set a position of a slider controlling the resistance to draw of the device to a particular position, or to set a particular power setting, or to clean or replace a component of the device. Such an indication may be given via an auditory signal, provided on a display screen or indicated via one or more LEDs, or provided on an external device to which the aerosol delivery device has a data connection (e.g. on an app running on a smartphone and associated with operation of the aerosol delivery device).

The foregoing discussion discloses and describes merely exemplary embodiments of the present disclosure. As will be understood by those skilled in the art, the present disclosure may be embodied in other specific forms without departing from the essential characteristics thereof. Accordingly, the content of the present disclosure is intended to be illustrative, but not limiting of the scope of the disclosure, as well as of the claims. The disclosure, including any readily discernible variants of the teachings herein, defines, in part, the scope of the foregoing claim terminology.

1. An electronic aerosol delivery system, comprising:
control circuitry configured to:
monitor at least one operating parameter of the electronic aerosol delivery system;
control at least one control parameter of the electronic aerosol delivery system to generate an aerosol having a first aerosol profile during a first puff;
determine a change in one or more of the at least one operating parameter; and
in response to determining the change in one or more of the at least one operating parameter parameters, to modify a control parameter of the at least one control parameter of the electronic aerosol delivery system to generate an aerosol having a second aerosol profile during a subsequent puff.

2. The electronic aerosol delivery system of claim 1, wherein each of the at least one operating parameter and the at least one control parameter is associated with one of the following aspects of operation:
supply of power to an aerosol generating component, control of airflow in the electronic aerosol delivery system, supply of aerosolizable material to the aerosol generating component, or another aspect of operation of the electronic aerosol delivery system; and
wherein the control parameter modified by the control circuitry is associated with a different aspect of operation than that of the one or more of the at least one operating parameter determined to have changed.

3. The electronic aerosol delivery system of claim 1, wherein the control parameter is modified in a manner which mitigates against a change in one or more characteristics of the first aerosol profile resulting from the change in the one or more of the at least one operating parameter.

4. The electronic aerosol delivery system of claim 3, wherein the first aerosol profile comprises a plurality of aerosol characteristics, and wherein the control parameter is selected to mitigate against a change in one or more of the plurality of aerosol characteristics, and wherein the one or more of the plurality of aerosol characteristics are selected from the plurality of aerosol characteristics based on a predetermined priority ranking of the plurality of aerosol characteristics.

5. The electronic aerosol delivery system of claim 4, wherein the predetermined priority ranking of the plurality of aerosol characteristics is associated with a specific user of the electronic aerosol delivery system.

6. The electronic aerosol delivery system of claim 1, wherein the electronic aerosol delivery system further comprises an aerosol generating component, and wherein determining the change in the one or more of the at least one operating parameter comprises determining a change in an operating parameter of the aerosol generating component.

7. The electronic aerosol delivery system of claim 6, wherein determining the change in the operating parameter of the aerosol generating component comprises determining a change in a capacity of a power supply to supply power to the aerosol generating component.

8. The electronic aerosol delivery system of claim 7, wherein determining the change in the capacity of the power supply to supply power to the aerosol generating component comprises determining that a value associated with an amount of energy remaining in the power supply has changed with respect to a predefined threshold.

9. The electronic aerosol delivery system of claim 7, wherein the control circuitry is configured to control a supply of power from the power supply to the aerosol generating component in accordance with a power supply parameter specifying an amount of power to be supplied to the aerosol generating component, and wherein determining the change in the capacity of the power supply to supply power to the aerosol generating component comprises determining that the power supply is not able to supply the amount of power specified by the power supply parameter.

10. The electronic aerosol delivery system of claim 7, wherein determining the change in the operation of the aerosol generating component comprises determining a physical characteristic of the aerosol generating component has changed.

11. The electronic aerosol delivery system of claim 2, wherein aerosolizable material is supplied to the aerosol generating component from a supply of aerosolizable material, and wherein the at least one operating parameter comprises a parameter controlling the supply of the aerosolizable material to the aerosol generating component.

12. The electronic aerosol delivery system of claim 11, wherein modifying the parameter controlling the supply of aerosolizable material to the aerosol generating component changes a rate at which the aerosolizable material is supplied to the aerosol generating component.

13. The electronic aerosol delivery system of claim 11, wherein modifying the supply of aerosolizable material to the aerosol generating component comprises modifying a composition of the aerosolizable material supplied to the aerosol generating component.

14. The electronic aerosol delivery system of claim 13, wherein modifying the composition of the aerosolizable material supplied to the aerosol generating component comprises modifying a concentration of at least one of: water, an active material, an olfactory component or an aerosol-forming constituent.

15. The electronic aerosol delivery system of claim 2, wherein the electronic aerosol delivery system comprises an air flow path between an air inlet and an air outlet, wherein the aerosol generating component is disposed within the air flow path, and wherein the operating parameter comprises a parameter which modifies the air flow path.

16. The electronic aerosol delivery system of claim 15, wherein modifying the air flow path comprises modifying a resistance to draw of air flow through the air flow path.

17. The electronic aerosol delivery system of claim 15, wherein modifying the air flow path comprises modifying a manner in which incident air flowing from the air inlet is directed at the aerosol generating component.

18. The electronic aerosol delivery system of claim 15, wherein modifying the air flow path comprises modifying a temperature of the aerosol generating component disposed in the air flow path.

19. The electronic aerosol delivery system of claim 1, wherein the control circuitry is further configured to determine how to modify the control parameter using a model which relates one or more operating parameters to one or more aerosol characteristics, and wherein the one or more operating parameters comprise at least one control parameter.

20. The electronic aerosol delivery system of claim 19, wherein the model is parameterized using experimental data describing how at least one aerosol characteristic of an aerosol generated by the electronic aerosol delivery system varies as a function of different operating parameter values.

21. The electronic aerosol delivery system of claim 1, wherein the control circuitry is further configured to determine how to modify the control parameter using a classifier which takes at least one operating parameter value as an input, and returns at least one control parameter value as an output.

22. The electronic aerosol delivery system of claim 21, wherein the classifier is trained using usage data describing a relationship between one or more operating parameter changes and one or more control parameter changes determined by one or more users in response to the one or more operating parameter changes.

23. Control circuitry for an electronic aerosol delivery system, comprising:
at least one processor and memory configured to:
monitor at least one operating parameter of the electronic aerosol delivery system;
control at least one control parameter of the electronic aerosol delivery system to generate an aerosol having a first aerosol profile during a first puff;
determine a change in one or more of the at least one operating parameter parameters; and
modify, in response to determining change in the one or more of the at least one operating parameter, a control parameter of the at least one control parameter of the electronic aerosol delivery system to generate an aerosol having a second aerosol profile during a subsequent puff.

24. A method of controlling an electronic aerosol delivery system comprising control circuitry, the method comprising:
monitoring, by the control circuitry, at least one operating parameter of the electronic aerosol delivery system;
controlling, by the control circuitry, at least one control parameter of the electronic aerosol delivery system to generate an aerosol having a first aerosol profile during a first puff;
determining, by the control circuitry, a change in one or more of the at least one operating parameter; and
modifying, by the control circuitry and in response to determining the change in the one or more of the at least one operating parameter, a control parameter of the at least one control parameter of the electronic aerosol delivery system to generate an aerosol having a second aerosol profile during a subsequent puff.

25. A non-transitory computer-readable storage medium storing a computer program for an electronic aerosol delivery system, wherein the computer program, when executed by a computer, is configured to cause the computer to:
monitor at least one operating parameter of the electronic aerosol delivery system;
control at least one control parameter of the electronic aerosol delivery system to generate an aerosol having a first aerosol profile during a first puff;
determine a change in one or more of the at least one operating parameter; and
modify, in response to determining the change in the one or more of the at least one operating parameter, a control parameter of the at least one control parameter of the electronic aerosol delivery system to generate an aerosol having a second aerosol profile during a subsequent puff.
